(19) United States
(12) Patent Application Publication
(10) Pub. No.: US 2007/0283908 A1
(43) Pub. Date: Dec. 13, 2007

(54) Tse's internal combustion engine

(76) Inventor: Kwong Wang Tse, Hong Kong (CN)

Correspondence Address: Kwong Wang Tse;Unit 17A, Block One, No.1, Wo Hong Path, Kwun Tong, Kowloon, Hong Kong, omitted

(21) Appl. No.: 11/447,748

(22) Filed: Jun. 7, 2006

(51) Int. Cl. F02B 75/22; F02B 25/00

(52) U.S. Cl. 123/54.3; 123/65 R

(57) ABSTRACT

Improvements of internal combustion engine brought in by this invention includes extracting four stroke engine cycle to two stroke cycle by construction of corresponsive partition, fuel inlet and emission outlet forming a pathway in combustion chamber allowing fresh fuel refilling and emission exhaustion processing simultaneously and between time for piston moving from downward turning to upward, improving operation of bifurcated legs by construction of corresponsive ditches and rims, introducing a power-dispersing unit consisting members of gears of axle, disperse, ratchet and swing to reduce powerful impacting force from combustion to acceptable on main axle evenly around, introducing a two fuel combustion process consuming two fuels instead of one taking advantage of economical, environmental and powerful second fuels by a consecutive spraying process.

### FIELD OF THE INVENTION

This invention relates to internal combustion engines and, more particularly, to improvement of general internal combustion engines and tse's invention of U.S. Pat. No. 6,722,322 on their combustion process, power delivery, fuel intake, bifurcated legs, ratchet gear and double fueled system. More specifically, this invention relates to improvements on operations of general and Tse's patented internal combustion engine of the four-stroke type, such as fuel intake, bifurcated legs, ratchet gears and double fueled system for combustion process and power delivery.

### BACKGROUND OF INVENTION

Internal combustion engines are widely used for human activities as power plants and apparatuses such as automobiles, power generators, pumps, compressors, ships, tractors, machines, and airplanes. In order to find better and better internal combustion engines, inventors and engineers are endeavoring by their professional skills and technologies to introduce new and improved internal combustion engines on every parts of the engine operation. In general, 1) fuel intake, 2) compression, 3) combustion, 4) exhaustion are typical steps involved in a complete engine operation cycle of a conventional four-stroke internal combustion engine. As each of these steps take over one stroke of piston movement but only the combustion step give power to all four steps of an engine cycle, it is a chance to give improvement if other steps can be eliminated or extracted. In a four cylinder-four stroke cycle engine, combustion in one cylinder gives power to support operations of total four cylinders. It is another chance to give improvement if combustion in one cylinder can support only one or two cylinder stead of four to complete a cycle of four stroke engine operation.

My U.S. Pat. No. 6,722,322 involves two bifurcated legs operating in the cylinder to deliver power from the piston to outside able to complete four stroke engine cycle by one combustion in one cylinder. As these bifurcated legs are working within combustion chamber, they are highly affected by continuous combustions inside cylinder causing them vibrating during operation. Improvement can be made to eliminate their vibrations in reciprocating movements so as making the operating more smooth and rigid.

Another invention in my U.S. Pat. No. 6,722,322 is two ratchet cogwheels with their engaging bifurcated legs working in opposite direction to maintain a continuous revolving movement to main axle from reciprocating movement of piston. The continuous impacts from combustion to bifurcated legs, ratchet cogwheels and main axle possibly bring damages to them because of the enormous combustion power is delivering from high speed bifurcated legs to ratchet cogwheel and then loaded axle. An improvement of present invention is to minimize such damages and bring the mechanism of whole engine working more smoothly and safely with least damages.

Most internal combustion engine consumes one fuel especially fossil fuel at a time and is not easy to swap to other economical fuels as hydrogen, steam or vegetation oil. It is beneficial to owners of internal combustion engine if it can consume two fuels at a time taking advantages of any economical, environmental and flexible second fuel to minimize consumption of costly and contaminative fossil fuels.

### OBJECT OF THE INVENTION

Hence, it is an object of the present invention to provide an improved internal combustion engine or engine topology which overcome or, at least, mitigate disadvantages associated with conventional internal combustion engines or my inventions from my patent. More specifically, it is an object of the present invention to provide an improved internal combustion engine or engine topology which serves to improve engine performance by reducing the engine weight-to power output ratio. It is also an object of present invention to provide an internal combustion engine or engine topology in which the piston only needs to go through a single set of leniently reciprocal motion in order to complete the fuel intake, compression, explosion and exhaust cycles of an engine operation. It is another object of present invention to provide improvements to strengthen parts in operation of internal combustion engine as bifurcated legs and ratchet cogwheels, or between combustion chamber and main axle. It is also another object of the present invention to provide an internal combustion engine able to consume two fuels combusting in same cylinder. As a minimum, it is al least an object of the present invention to provide the public with a choice of a novel internal combustion engine or engine topology to be described hereinafter.

### SUMMARY OF INVENTION

In view of the afore-said objectives and according to the present invention, there is provided an internal combustion engine including at least one engine cylinder, said cylinder includes a cylinder cavity with a cylinder head and a piston. A fuel inlet and an emission outlet are installed on the cylinder head. In order to eliminate two or three strokes from a four-stroke cycle internal combustion engine for saving number of cylinders, it is required to find out which strokes are able to be eliminated from 1) intake of fuel, 2) compression, 3) combustion, 4) exhaustion. Combustion is the only stroke cannot be eliminated for it is the production of power to exercise the engine. Therefore, intake, compression and exhaustion are strokes can be eliminated or grouped together into one stroke.

Preferably, said engine cylinder just taken a combustion pushes said piston to its extreme low position delivering its combustion power to outside mechanism. Said exhaustion outlet is open for emission to run out. At the same time, inlet of fuel is open for refill of fresh vaporized combustible fuel. As fresh fuel from inlet is injected into the combustion chamber by high pressure, it is arranged both processes to be operated at same time allowing refilling of fuel taking over emission in combustion chamber orderly. As higher the pressure brings higher the fuel injection speed. When intake of fresh fuel spray into the combustion chamber with right high pressure, it fills up the combustion chamber and pushes all emission away by the help of the arranged constructions of fuel nozzle, emission outlet and partition on cylinder head. Filling of fuel finishes in a short time by open and close of inlet and outlet simultaneously before said piston starting to run back for compression can save two strokes in engine operation out of four.

Preferably, bifurcated legs of my invention U.S. Pat. No. 6,722,322 is an invention able to allow a piston to be combusted on both sides by consecutive combustions within a single cylinder having a combined function of two cylinders of a conventional internal combustion engine. In order to have a smooth reciprocating movement of piston, rigid bifurcated leg, clear and reliable track of movement are required for firm movement of bifurcated legs avoiding harmful vibrations. Ditch or ditches are dug on the internal wall of the combustion cylinder for the running of jutting rim or rims from corresponding back of bifurcated legs allowing bifurcated legs to running along said ditches firmly by holding of jutting rims.

Preferably, combustion power from combustion chamber of an internal combustion engine to loaded main axle by reciprocating piston is a great force easily damaging to gears or parts working in between. Present invention introduces a power-dispensing unit including-swing gear, ratchet gear, dispense gear and axle gear placed between bifurcated leg or connecting part and main axle. A power-dispensing unit able to deliver destructive combustion power to main axle all around evenly and revolve the axle at first moment. This arrangement allows bifurcated legs deliver combustion power from piston to axle safely and able to revolve the axle with minimum impact to their contacting parts.

Preferably, most internal combustion engine consumes one fuel only especially petroleum fuel making human rely on fossil fuels deeply. In order to lessen dependency and contamination of fossil fuel, it is good to bring an improvement of internal combustion engine for two fuels can be consumed at same time on general engine operation. Taking use the high combustion temperature and pressure in combustion chamber during engine operation of first fuel, second fuel is directly sprayed to combustion in chamber bringing a simultaneous or second combustion. New invented simultaneous combustion has a combined power of two fuels, thus saving possibly half of fossil fuel and introducing an economical and environmental replacement such as vegetation oil, alcohol, hydrogen, steam and hydrocarbon. It is also an important step to bring in hydrogen as first fuel for it is highly combustible and steam as second fuel for its hydrogen composition making a very economical and environmental pair of fuels.

### BRIEF DESCRIPTION OF THE DRAWINGS

Preferred embodiments of the present invention of an internal combustion engine or engine topology will be explained in more detail in the specific description below by way of examples and with reference to the accompanying drawings in which:

FIG. 1a shows an intersected vertical diagram of an internal combustion engine cylinder illustrating the principle of improved operation of a first embodiment for grouping processes of intake, compression and exhaustion into one stroke of the present invention.

FIG. 1b shows a second example of same improved process as FIG. 1a.

FIG. 1c shows a third example of same improved process as FIG. 1a

FIG. 2a shows horizontally intersected diagram of an internal combustion engine cylinder illustrating the principle of improved design of bifurcated legs for a steady and firm reciprocating movement in engine operation.

FIG. 2b shows different example of same improved bifurcated legs design as FIG. 2a.

FIG. 3a shows an example of axle gear of a power-dispersing unit on its front view holding on axle.

FIG. 3b shows an intersected side view of FIG. 3a.

FIG. 3c show an oblique grid view of FIG. 3a.

FIG. 4a shows a front view of an example of disperse gear of a power-dispersing unit.

FIG. 4b shows an intersected side view on halfway of FIG. 4a.

FIG. 4c shows an oblique grip view of FIG. 4a.

FIG. 5a shows a combined side view of amalgamated axle gear and disperse gear. FIG. 5b shows an enlarged amalgamated intersecting front view of their top teeth from FIG. 5a with ratchet gear and part of swing gear.

FIG. 5c shows more details of FIG. 5b with their operating relations.

FIG. 6a shows a front view of an example of swing gear with one ratchet gear.

FIG. 6b shows an oblique grip view of FIG. 6a.

FIG. 6c shows a front view of another example of swing gear with a number of ratchet gears.

FIG. 7a shows an example for connections between cylinder, bifurcated legs, power-dispersing unit and axle.

FIG. 7b shows another example for connections between cylinder, bifurcated legs, power-dispersing unit and introducing swing handle to take over swing gear.

FIG. 8a shows an example of an intersected cylinder of internal combustion engine able to consume two fuels for combine combustion taking first fuel into combustion chamber.

FIG. 8b shows same example of FIG. 8a for combined combustion of two fuels.

FIG. 8c shows another example for combined combustion of two fuels.

### DETAILED DESCRIPTION OF THE PREFERRED EMBODIMENTS

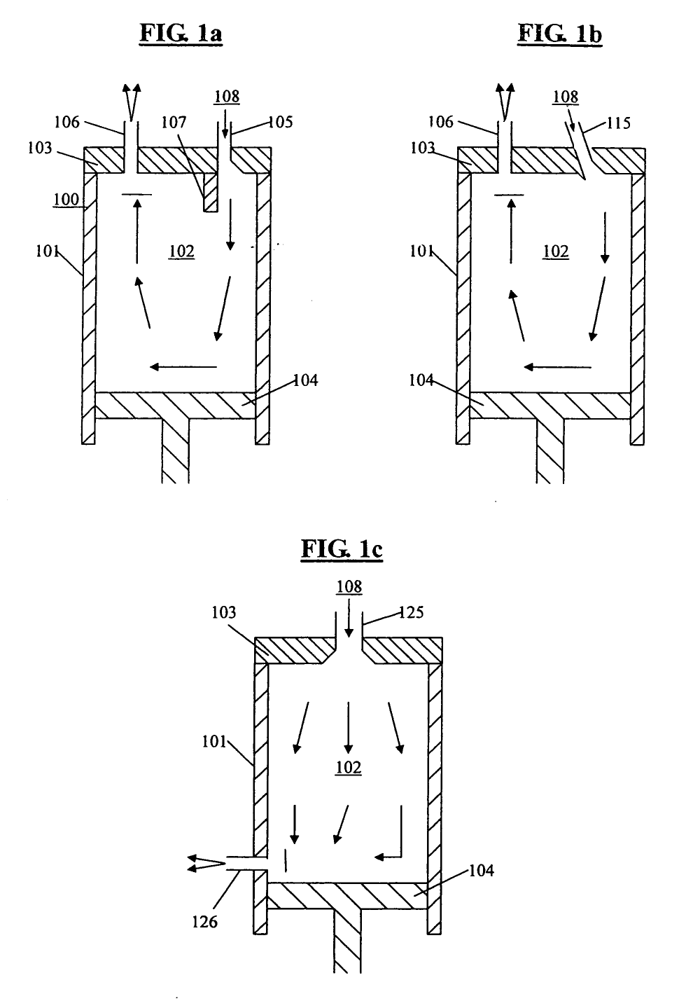

Referring firstly to FIG. 1a there is shown simplified sketch of a first preferred embodiment of the present invention of a cylinder of an internal combustion engine. The figure shows an improvement of engine operation of grouping processes of fuel intake, compression and exhaustion from a four stroke cycle in internal combustion engine cylinder into two strokes for saving of two strokes and maintaining most of combustion power. Said engine generally includes at least one engine cylinder, although a plurality of engine cylinders may be, and are generally connected together to meet with specific power and operation requirements and to fulfill various performance criteria.

The cylinder (100) generally includes a hollow cylinder housing (101) having cavity (102) with a cylinder head (103) on the top and a piston (104) working within said cavity (102). Fuel inlet (105) and emission outlet (106) are built on right and left of said cylinder head (103). A partition or fencing wall (107) is built under said cylinder head (103) closing to said fuel inlet (105) in condition of said partition or fencing wall (107) being built not too low to obstruct the operation of said piston (104). On FIG. 1a piston (104) is on its lowest extreme position driven down by combustion in cylinder cavity (102). On the moment when piston (104) has reached its lowest position, fuel inlet (105) and emission outlet (106) are open at same time or nearly same time. Vaporized fuel (108) is ready to inject by high pressure from inlet (105) into cylinder cavity (102) and following the separation of fencing wall (107) going to the right side of the cylinder cavity (102) then straight down to said piston (104). As emission outlet (106) is open at same time, emission from combustion is running out immediately from cylinder cavity (102) by its high emission pressure through said outlet (106). Because of inlet (105) and outlet (106) are open at same time or nearly same time, fuel (108) comes in and emission goes out of cylinder cavity (102) happened at the same time. Arrows in cylinder cavity (102) show direction of fuel replacement of emission. High pressure vaporized fuel (108) forces all emission to go out and replace them orderly by the help of the fencing wall (107) as fuel (108) has a pathway to go around said cylinder cavity (102). Higher the pressure of vaporized fuel, faster speed it can have to make a very short interval time between open and close of inlet (105) and outlet (106). Right high pressure of fuel (108) is decisive to a smooth and quick exchange of emission to fuel and can be finished shortly right after piston starts to go up for compression. By the construction of fencing wall (107) under cylinder head (103), positions of fuel inlet (105) and exhaustion outlet (106) with adequate high pressure of fuel in this invention, processes of fuel intake, compression and exhaustion in a four stroke cycle of an internal combustion engine operation are grouped and extracted for operation of two stroke cycle with minimal lose of power in new process.

FIG. 1b is a second example of same embodiment as FIG. 1a but having a different arrangement in fuel inlet. New fuel inlet (115) is installed for this example having the same function of inlet (105) as in FIG. 1 with its special fuel in-taking direction by specific nozzle making. Without help of fencing wall from cylinder head (103), fuel inlet (115) forces its vaporized fuel to go into cylinder cavity (102) from the right side of cylinder cavity (102) to its bottom by the specific injecting direction of inlet (115) following a pathway up to emission outlet (106) to replace all emission in cavity by constructions of fuel inlet (115) After highly pressurized vaporized fuel finishes its replacement and refill in cavity (102) with inlet (115) and outlet (106) closed immediately, piston (104) starts right after or shortly after to run back for compression of fuel.

FIG. 1c is a third example for having same improved function as FIG. 1a but with different fuel inlet (125) and emission outlet (126) constructions. New fuel inlet (125) is located in the middle of cylinder head (103) with a bigger and wider round spreading nozzle for a better result of faster and all around fuel injection. As new emission outlet (126) is located at bottom of cylinder housing (101), an all around fuel injection from top middle of cylinder can form a fast and complete fuel replacement of emission. This example can bring a shorter time for replacement of fuel than other two examples of FIG. 1a and FIG. 1b as it has a bigger supply of fuel by bigger fuel inlet (125) and a shorter distance for fuel to travel. The interval time between open and close of both inlet (125) and outlet (126) can be shorter to complete for faster fuel intake and exhaustion, thus giving piston (104) a longer time for compression in operation. FIG. 1a, 1b and 1c are three examples of same embodiment for different choices of engine making considering different requirements applicable to general four stroke cycle internal combustion engine and my invention U.S. Pat. No. 6,722,322 replacing of its complicated diaphragms. This invention able to reduce engine weight-to-power output ratio for taking two strokes in engine operation instead of four as conventional internal combustion engine.

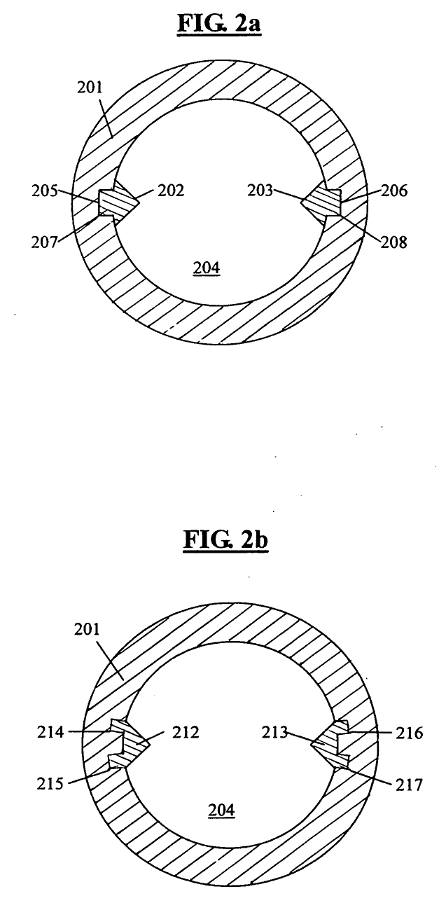

Referring to FIG. 2a and 2b are two examples having the same improved functions for working two bifurcated legs in connection of piston and main axle for delivery of combustion power in internal combustion engine operation as in my invention of U.S. Pat. No. 6,722,322. Two bifurcated legs in my said patent are working inside combustion chamber leading from under face of piston through lower cylinder head in connection to main axle resisting continuous combustion explosion. Any vibration from bifurcated legs caused by the combustion in combustion chamber is a serious damage to bifurcated legs and lower cylinder head and possibly obstructing engine running. FIG. 2a is a horizontally intersected diagram of cylinder (201) with two bifurcated legs (202, 203) working on right and left within cylinder cavity (204). Ditches (205, 206) are dug from internal wall of said cylinder (201) for holding jutting rims (207, 208) from said bifurcated legs (202, 203) respectively. Because said bifurcated legs (202, 203) are constructed for connection of piston and axle, their positions are firmly connected by piston and axle on two ends. Said bifurcated legs (202, 203) have an improved operation for holding jutting rims (207, 208) to run by said ditches (205, 206) along cylinder wall forming tracks in cylinder cavity (204) avoiding any vibrations caused by combustions in operation. FIG. 2b is a second example of embodiment same as FIG. 2a for having two jutting rims (214, 215) from bifurcated leg (212) and another two jutting rims (216, 217) from other bifurcated leg (213) instead of one jutting rim of each bifurcated leg as in FIG. 2a. Corresponding ditches have to be dug on internal wall of cylinder (201) for holding of these jutting rims (214, 215, 216 and 217) from their respective bifurcated legs (212, 213). This is a choice of engine making for the best result of engine operation considering different engine requirement. Internal combustion engine including jutting rim or rims for bifurcated legs running in corresponding ditches on cylinder wall holding bifurcated legs from any vibration during combustion bombardments brings operations more smoothly and peacefully within combustion chamber as bifurcated legs are required for combustions on both sides of piston in my invention of U.S. Pat. No. 6,722,322. It has the same operation effects by swapping positions of jutting rims from bifurcated legs to cylinder wall and ditches from cylinder wall to bifurcated legs whereas in conditions they have suitable corresponding positions for construction.

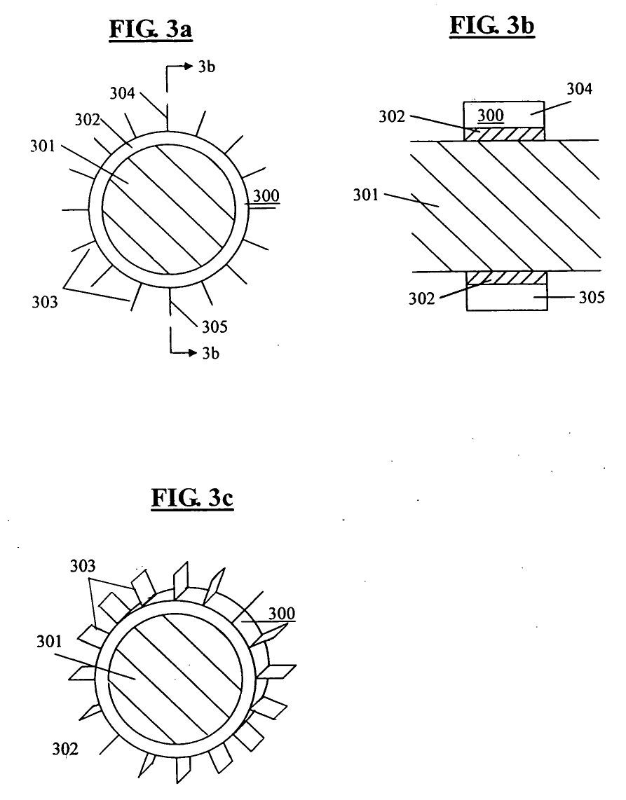

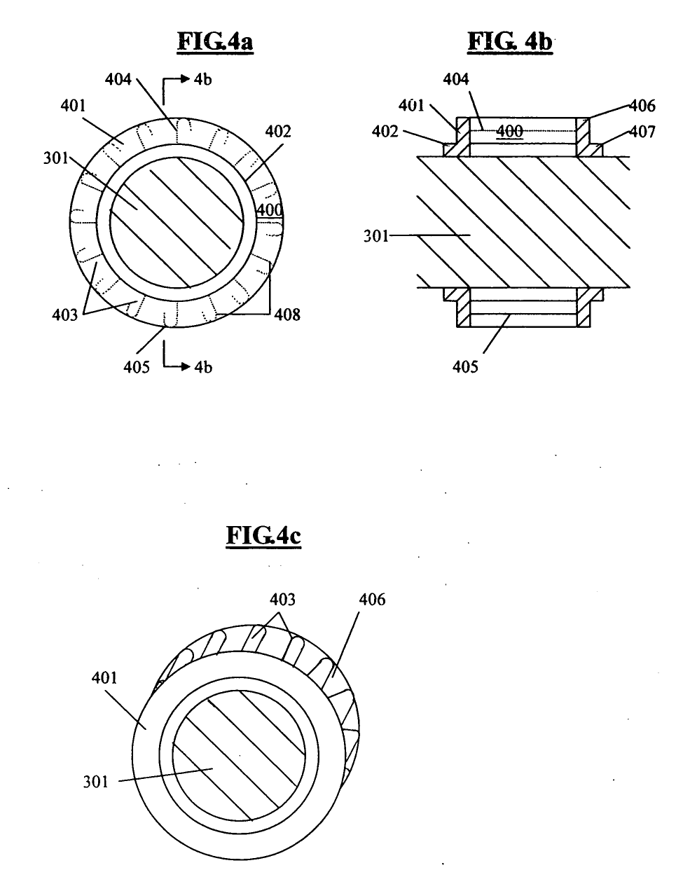

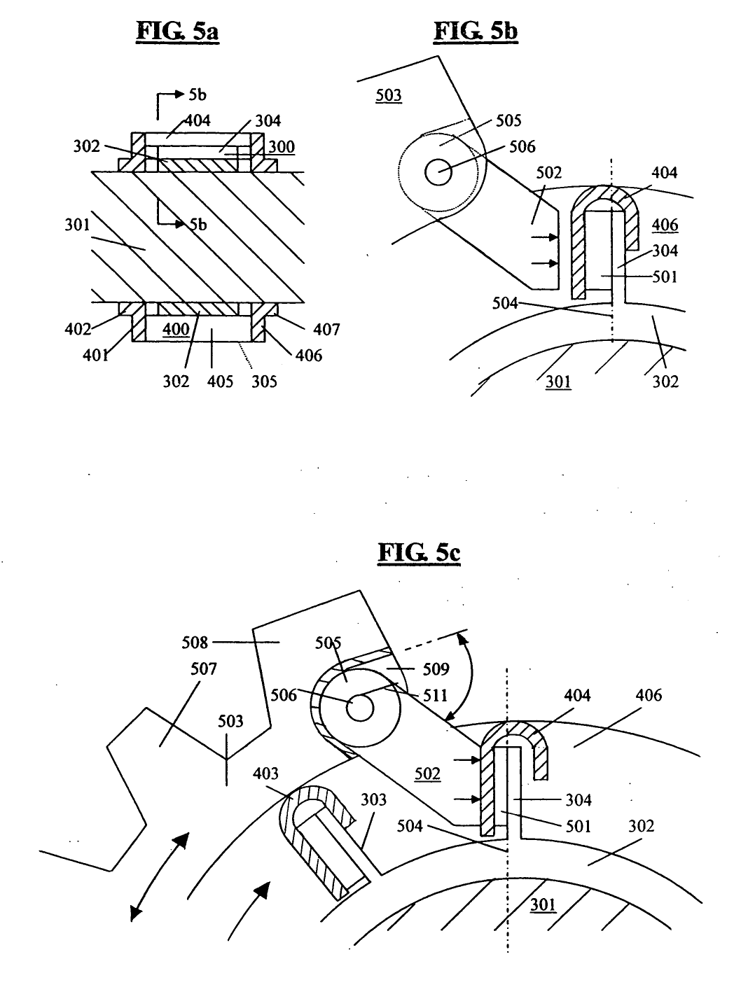

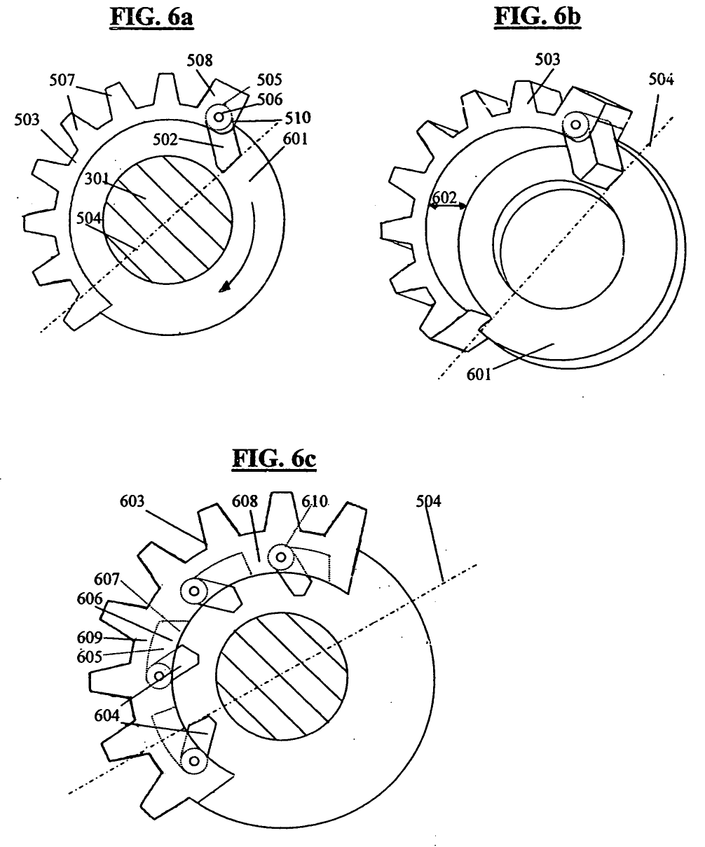

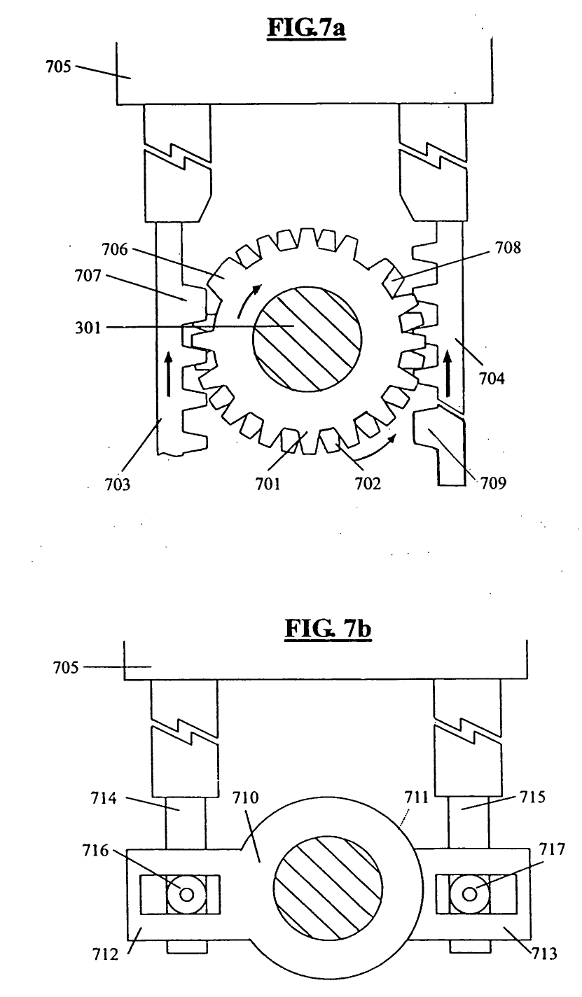

FIG. 3 to FIG. 7 are showing different members of an example of power-dispersing unit by simple diagrams for a third embodiment of present invention referring to different parts of an amalgamation of strengthened gears interconnected between piston and axle for combustion power delivery including axle gear—FIG. 3, disperse gear—FIG. 4, ratchet gear—FIG. 5, swing gear—FIG. 6 and an amalgamated diagram with bifurcated legs on FIG. 7.

FIG. 3a is a simplified diagram of front view of an example of axle gear (300) fastened with axle (301) on the ring (302).Gear teeth (303) are built all around on the said gear ring (302) with top tooth (304) and low tooth (305). When any of these teeth are pushed by a force from one direction, said axle gear (300) will turn around and revolve with said axle (301) together. FIG. 3b is a side view of FIG. 3a intersecting in half showing gear ring (302) is fastened or mounted on said axle (301) tightly with top tooth (304) and low tooth (305) built from said gear ring (302). FIG. 3c is an oblique grid view of axle gear (300) from FIG. 3a for having a clear vision of said gear teeth (303) from gear ring (302) fastening on axle (301).

FIGS. 4a-c is series of simplified diagrams of different views for an example of disperse gear. Referring to FIG. 4a is front view of disperse gear (400) constructed by two discs (401, 406) whereas disc (401) is shown on the front and disc (406) is on its back. Supporting disc base (402) is a protruding disc round base supporting said disc (401) for revolving around axle (301) of the same axle as in FIG. 3a. Said disperse gear (400) is not fastened tightly with axle (301) but holding loosely and able to revolve freely around it. Gear teeth (403) erected between two said disc (401, 406) shown in dotted lines are teeth built evenly all around said disperse gear (400) with top tooth (404) on the top and low tooth (405) on the bottom. All pointing out ends (408) of said gear teeth (403) are bended as in figure.

FIG. 4b is a side view of FIG. 4a about said disperse gear (400) intersecting in half. Axle (301) is running in the middle held on loosely by said disperse gear (401) and they are not tightly fastened in operation. Circular discs (401, 406) are on left and right with their supporting disc bases (402, 407) respectively. Top gear tooth (404) is on the top and low gear tooth (405) is on the bottom of said disperse gear (400). When any gear tooth (403) of said disperse gear (400) is pushed by a force in one direction, whole disperse gear would revolve around said axle (301) without any connections to each other. FIG. 4c is an oblique grip view from FIG. 4a for a clear understanding vision for some said teeth (403) seen between two discs (401, 406) with axle (301) running in middle. Number of disperse gear teeth (403) is made same as number of axle gear teeth (303).

Referring to FIG. 5a-c are simplified diagrams of amalgamation and workings of axle gear (300) and disperse gear (400) with examples of ratchet gear and swing gear of the power-dispersing unit. FIG. 5a is an intersected amalgamated diagram from FIG. 3b and FIG. 4b. Said axle (301) and axle gear (300) are fastened together on gear ring (302) and disperse gear (400) is holding loosely and enclosing on them by two discs (401, 406) with their supporting disc bases (402, 407). All axle gear teeth are endosed by every bending heads of all disperse gear teeth whereas top tooth (304) of axle gear (300) is placed under top tooth (404) of disperse gear (400) and low tooth (305) of axle gear (300) is installed under and behind low tooth (405) of disperse gear (400) pointed out by dotted line on the FIG. 5a.

FIG. 5b and 5c showed by enlarged figures on how both axle and disperse gears (300, 400) can work out power dispersing effects from their enlarged top teeth (304, 404) together with members of ratchet gear and swing gear representing same effects on other teeth. Referring to FIG. 5b, it shows an enlarged intersected side-view figure from FIG. 5a on the part of top axle gear tooth (304) enclosed by the bending head of top disperse gear tooth (404) with a member of shock absorbent or piece of rubber (501) placed between two said teeth (304, 404). An example of ratchet gear (502) installed in an example of swing gear (503) is coming into position to push disperse tooth (404). Center line (504) of axle (301) is running between two teeth (304, 404) for having a consequence of two said teeth (304, 404) can be overlapping towards each other thoroughly on their opposite faces. Axle gear ring (302) is connecting to all axle teeth (303) and disperse gear disc (406) is connecting to all disperse teeth (403) for their forward moving operation. Said ratchet gear (502) includes a pivoted pushing tooth (505) controlled its swinging action by hinge (506) for each pushing action towards disperse tooth (404) or other disperse teeth on operating its ratchet function.

FIG. 5c shows more details of ratchet gear (502) hitting on disperse tooth (404) and pushing it towards rubber (501) or a similar shock absorbent member. Rubber (501) is squeezed into a smaller size as tooth (304) of axle gear (300) is backed up by fastening to axle (301) with loaded mechanism. Squeezing of rubber brings distance between two teeth (304, 404) comes smaller and all disperse teeth (403) has been moved at the same time to all rubbers (501) and then all axle teeth (303) because disperse gear (400) is free to revolve on axle (301). As ratchet gear (502) is keeping on pushing, disperse tooth (404) and rubber (501) are keeping on pushing on axle tooth (304) bringing all disperse gear teeth (403) are pushing on all axle gear teeth (303) too. Axle (301) has been revolved by pushing of ratchet gear (502) for numbers of both said teeth (303,403) of axle gear (300) and dispersing gear (400) are made the same, said disperse gear (400) is free for revolving and said axle gear (300) is fastened with axle (301) by their amalgamated workings.

Swing gear (503) is a member of power-dispersing unit for receiving of power from combustion chamber to drive ratchet gear (502) for pushing movements including driving teeth (507) for receiving of power, pusher (508) for pushing and hinge holders (509, 510) for holding of hinged said ratchet gear (502) including pivoted pushing tooth (505) and hinge (506). Hinge holder (510) is taken off in FIG. 5c for a clearer internal view of pusher (508), hinge holder (509), ratchet gear (502) and the swing span of pivoted pushing tooth (505). Pivoted pushing tooth (505) is closely touching with pusher (508) of swing gear (503) between two hinge holders for delivering of combustion power on pushing with a pivoted swinging allowance for ratchet function. When ratchet gear (502) and swing gear (503) has slowed down after finished their pushing function on disperse tooth (404), next tooth (403) from revolving movement of disc (406) coming in to hit ratchet gear (502) at its back making pivoted pushing tooth (505) to swing around hinge (506) to get away from rotation span of tooth (403) for carrying out its ratchet function. A spring member (511) is connecting ratchet gear (502) and hinge (506) for carrying out its swinging function for ratchet gear (502) to bounce back to its pushing position for next push. Details of spring member (511) are similar to attached Reference-1 from FIG. 13c of my U.S. Pat. No. 6,722,322. Swing gear (503) has worked out every pushing action by swinging forward once with ratchet gear (502) to push disperse gear (400) and swinging back to its original position bringing ratchet gear (502) slips away from all disperse teeth for next pushing.

On every pushing by the corresponsive workings of swing gear (503), ratchet gear (502), disperse gear (400) and axle gear (300), combustion power from combustion cylinder has revolved axle (301) with its loaded mechanism by moving of teeth of axle gear (300) all around and evenly dispersed such combustion power to every said axle teeth (303). Such destructive force of combustion power has divided by total number of teeth (303) of axle gear making delivery of power coming to be practical and safe. More number of teeth means less power to be resisted by each tooth and also bigger area of tooth face means less power per unit area on each tooth face to be resisted. FIGS. 6a-c is series of simplified diagrams explaining more details in construction of members of swing gear and ratchet gear with their working relationships. Referring to FIG. 6a, it is a full front view of an example of swing gear (503) consisting swing disc (601), driving teeth (507), pusher (508) and hinge holder (510). Example of ratchet gear (502) is annexed to said swing gear (503) with pivoted pushing tooth (505) partly shown in dotted circle for partly hidden under hinge holder (510) held by hinge (506) for pivoting action. Swing disc (601) is a circular disc joining all said driving teeth (507) with ratchet gear (502) and holding axle (301) in center loosely for swinging. Center line (504) of axle (301) is directly on the pushing direction of ratchet gear (502). When driving teeth (507) is driven by combustion power to revolve around axle (301), it carries ratchet gear (502) to revolve thus pushing gears of disperse and axle to revolve by its pivot pushing tooth (505).

Referring to FIG. 6b, an oblique grip view of FIG. 6a is showing a better understanding in connections between ratchet gear (502) and swing gear (503) relating to swing disc (601) and driving teeth thickness (602). Depth of driving teeth thickness (602) joint with swing disc (601) shown by arrows is a thickness has enough strength built to resist impact from corresponding bifurcated leg whereas thicker of the thickness brings stronger the strength, and enough room is reserved for disperse gear and axle gear working within. Referring to FIG. 6c is another example of swing gear (603) for having a number of ratchet gears (604) stead of one installed in ditches (605) built by excavations between two hinge holders (606, 607), pusher (608) and driving teeth thickness (609) for each ratchet gears (604). Each ditches (605), lower hinge holders (607), part of ratchet gears (610) are shown and pointed out by dotted lines for built under each top hinge holders (606). Example of FIG. 6c shows more numbers of pushers (608) and ratchet gears (604) averaging impacting power delivered on each of them from combustion. Number of ratchets required is depended on design and requirement of different engine making. It is another choice of engine making of having driving teeth (507) and ratchet gears (604) fully around swing disc (601).

FIG. 7a is an overall front view of two swing gears (701, 702) with their bifurcated legs (703, 704) engaging respectively on left and right in their teeth to each other for operation. Swing gear (701) is on the front and swing gear (702) is under it with their own members of ratchet gears, disperse gears and axle gears installed inside. Two bifurcated legs (703, 704) are protruding from combustion chamber of cylinder (705) for delivery of combustion power to power-dispersing unit. As two said swing gears (701, 702) with their ratchet gears are installed in opposite swinging directions, their different ratchet pushing directions by each combustion bring axle (301) to revolve continuously in operation of internal combustion engine as stated in my patent U.S. Pat. No. 6,722,322. A stronger ratchet mechanism is invented in this invention for improving operation on receiving of power. Two swing gears (701, 702) are constantly engaging with respective bifurcated legs in their teeth for receiving of power bringing minimal impact from minimal thrust to each other for delivery of power safely and efficiently. Two said swing gears (701, 702) has full driving teeth all around both swing gears having a longer possible swinging span than swing gears (503, 603) in FIGS. 6a-c. Driving tooth (706) of swing gear (701) and pushing tooth (707) of bifurcated leg (703) are made doubled in size and reinforced for they are the first pair of engaging teeth on contact for pushing action carrying most of combustion power for delivery. Same functional double sized and reinforced driving tooth (708) of swing gear (702) is made for receiving power from corresponsive pushing tooth (709) of bifurcated leg (704) whereas pushing tooth (709) is built on the end of bifurcated leg (704) for its pushing position.

Referring to FIG. 7b, it is another example of swing gears having same improved function as FIG. 7a with a pair of strong handles stead of driving teeth. Toothless swing gears (710, 711) are carrying their power-dispersing units inside whereas swing gear (711) is pointed out by dotted lines for it is hidden under swing gear (710). Rectangular handles (712, 713) are annexed to swing gears (710, 711) on right and left respectively with rectangles holes excavated. Toothless bifurcated legs (714, 715) protruded from cylinder (705) delivering power have no any pushing teeth but two roller gears (716, 717). Two said roller gears (716, 717) are hedged within two rectangle handles (712, 713) from swing gears (710, 711) respectively having function to roll on reciprocating bifurcated legs within said rectangular handles (712, 713). On every combustion from cylinder (705), two bifurcated legs (714, 715) move reciprocating up and down with their roller gears (716, 717) hedged by two excavated rectangular handles (712, 713) swinging their swing gears (710, 711) respectively. Two examples of FIGS. 7a and b have same function for delivering of power but example FIG. 7b has a stronger connection by a pair of roller gears and rectangular handles but possible shortest swinging span and reciprocating distance.

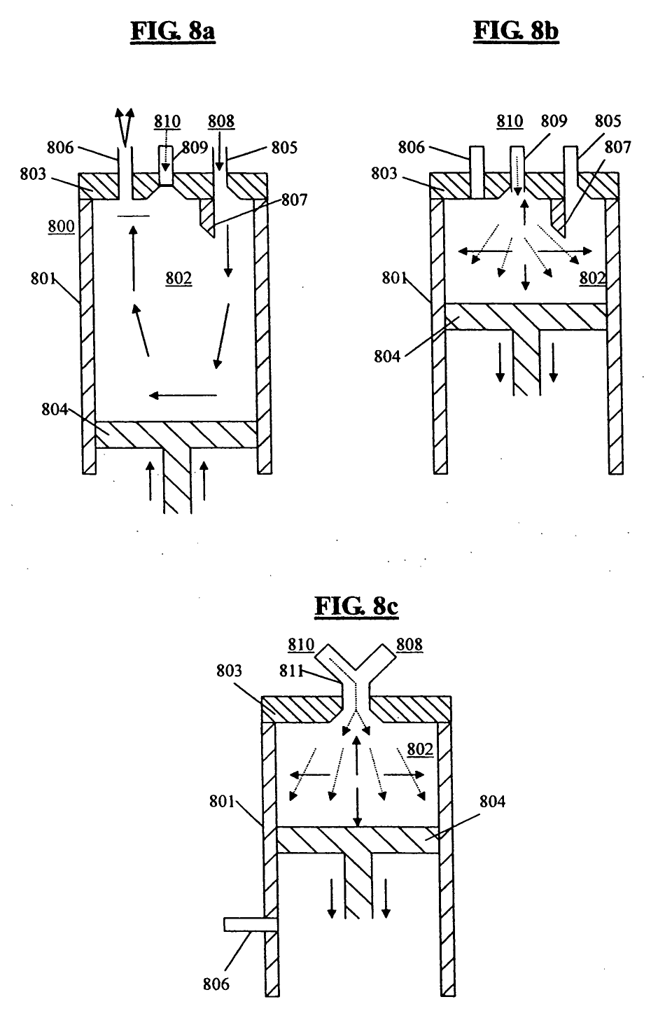

FIGS. 8a-c is series of simplified drawings of an internal combustion engine showing improvement of technology to have a second fuel for combustion consuming at same combustion for saving consumption of first fuel. Referring to FIG. 8a, an example of present invention shows an internal combustion engine (800) having cylinder (801), cylinder cavity (802), cylinder head (803) and piston (804). It has similar operation of two stroke cycle as FIGS. 1a-c of present invention that is when first fuel inlet (805) is refilling first fuel (808) with emission outlet (806) is open for exhaustion simultaneously. By help of construction of wall (807) from cylinder head (803), first fresh fuel (808) is coming into cylinder cavity (802) following a path to rid off emission out of said cavity (802) by same process as example of FIGS. 1a-c. When first fresh fuel (808) is refilling from inlet (805), pre-compressed second fuel (810) shown by dotted arrow is also storing in second inlet (809) or a storeroom at same time. Piston (804) is ready to go up for compression.

Referring to FIG. 8b, first fuel (808) compressed by piston (804) is exploding in cavity (802) shown in black arrows expelling piston (804) to a downward reciprocating movement. At the same time of combustion of first fuel (808) pre-compressed second fuel (810) shown by arrows of dotted lines is spraying into cylinder cavity (802) from second inlet (809) or storeroom. Taking use of the big heat and high pressure of first fuel (808) combustion, second fuel (810) is decomposed into its primary elements and exploding its combustible elements simultaneously making a joint, extended or second combustion. To work out this process in engine operation, second fuel (810) has to spray in the right time not too early before combustion for avoiding confusion of two fuels (808, 810), not too late for combustion is over, spray with right pressure in short time and no back fire is proved. Joint combustion of two fuels brings a bigger combustion thus saving consumption of first fuel. To operate this process, time of spraying of second fuel can be controlled either by closing of first fuel inlet (805), ignition of first fuel (808), pressure of first combustion, movement of piston (804) or their joint operation. After piston (804) is expelled by combustion of two fuels (808, 810) in cylinder cavity (802) to its utmost downward position, outlet (806) is open for exhaustion and first fuel inlet (805) is open for another fresh fuel refill to get rid of emission again simultaneously. It is another choice of engine making on exchanging first fuel to be non-combustible fuel with second fuel is combustible fuel spraying into cylinder with combustion combusting first non-combustible fuel thus forming a joint combustion of two fuels.

Referring to FIG. 8c, it is another example for a two fuels consumption internal combustion engine. First fresh fuel (808) shown in black arrows exploding in cylinder cavity (802) is come from right side of inlet (811) after being compressed by piston (804). It has a similar process to get rid of emission from outlet (806) by refilling of fresh fuel as FIG. 1c. Pre-compressed second fresh fuel (810) shown in arrows of dotted lines comes into cylinder cavity (802) from storage on left side of inlet (811) and spray right into combustion causing a simultaneous combustion by its big heat and pressure. Joint combustion of two fuels (808, 810) expels piston (804) goes down to its utmost downward position delivering combustion power to outside of cylinder cavity by a reciprocating movement. Two fuels (808, 809) can be arranged on same inlet (811) as FIG. 8c in condition of it has a two fuels processing system from right and left as in this example with a common spraying nozzle. Using two fuels in internal combustion engine combustion can save a lot of fossil fuel and taking advantages of using more economical, environmental and powerful fuels as a second fuel such as steam, hydrogen, emission, plantation oil, hydrocarbon, etc.

What is claiming is:

1. An internal combustion engine including at least one engine cylinder, said cylinder including a cylinder cavity and a cylinder head with corresponsive positions of a fuel inlet, an emission outlet and partition by constructions processing exhausting of emission and refueling of fuel operating simultaneously and orderly without confusing of emission and fresh fuel extracted processes of in-taking, compression, combustion and exhaustion of a four stroke cycle internal combustion engine into combustion and compression of a two stroke cycle.

2. An engine according to claim 1, said partition built from cylinder head between fuel inlet and emission outlet within combustion chamber forming a divided path for emission to be exhausted and fresh gaseous fuel in-taking processing simultaneously and orderly without confusing each other, taking use pressures of exhaustion and in-taking to refill fresh gaseous fuel in combustion chamber within time of piston operation between processes of combustion and compression.

3. An engine according to claim 1, said fuel in-taking inlet constructed corresponsive to position of exhaustion outlet forming an orderly path for emission to be exhausted and fresh fuel in-taking processing simultaneously and orderly, taking use pressures of exhaustion and in-taking to refill fresh gaseous fuel in combustion chamber within time of piston operation between processes of combustion and compression.

4. An engine according to claim 1, said exhaustion outlet constructed corresponsive to position and formation of fuel inlet forming an orderly path for emission to be exhausted and fresh fuel in-taking processing simultaneously and orderly, taking use pressures of exhaustion and in-taking to refill fresh gaseous fuel in combustion chamber within time of piston operation between processes of combustion and compression.

5. An engine according to claim 1, constructions of partition, outlet of emission and inlet of fuel in-taking corresponsive to each other in position and direction forming an orderly path for emission to be exhausted and fresh fuel in-taking processing simultaneously and orderly, taking use pressures of exhaustion and in-taking to refill fresh gaseous fuel in combustion chamber within time of piston operation between processes of combustion to compression results consequence of a four stroke cycle engine operation extracted to a two stroke cycle operation.

6. An internal combustion engine including at least one engine cylinder, includes a jutting rim or rims built from two bifurcated legs protruding from combustion chamber to outside for delivery of power running in a corresponsive ditch or ditches dug on cylinder wall for holding each other from vibrations in operation of reciprocating movement of bifurcated legs.

7. An engine according to claim 6 building in positions exchanged, includes a jutting rim or rims from wall of cylinder running in corresponsive ditch or ditches dug in bifurcated legs holding each other from vibrations in operation of reciprocating movement of bifurcated legs.

8. An internal combustion engine including a power dispersing unit for safe, efficient and even delivery of power built between piston and main axle includes members of axle gear, disperse gear, ratchet gear and swing gear in continuous engine running.

9. An engine according to claim 8, said member of disperse gear includes a number of gear teeth erected between two circular discs with bent heads revolving freely on axle for delivery of power.

10. An engine according to claim 9, said member of disperse gear encloses a member of axle gear by its bent teeth heads and circular discs delivering power from any number of teeth of disperse gear goes to all teeth of axle gear evenly all around revolving together with main axle.

11. An engine according to claim 10, said member of disperse gear encloses a member of axle gear by its bent teeth heads includes a member of power absorbent in between for delivery of power from disperse gear to axle gear for function of power absorbing.

12. An engine according to claim 8, said member of swing gear includes a number of gear teeth and a reinforced tooth on part of or all around swing disc holding and revolving freely on main axle receiving combustion power from reciprocating movements and converting them to circular revolving motion.

13. An engine according to claim 12, said member of swing gear includes a member of ratchet gear with ratchet function annexed for delivery of power from reciprocating movement to main axle in circular revolving motion.

14. A power-dispersing unit includes members of swing gears, ratchet gears, disperse gear and axle gear for delivery of power from reciprocating movement to circular revolving motion.

15. An internal combustion engine having improved operation extracting four cycle stroke to two cycle stroke by corresponsive constructions of fuel inlet, exhaustion outlet and partition, builds corresponsive jutting rims and ditches on bifurcated legs and cylinder wall for smooth running avoiding vibrations, installs power dispersing unit of members of swing gear, ratchet gear, disperse gear, absorbent, axle gear for effective power dispersing evenly to main axle.

16. An internal combustion engine has improved operation for having two fuels consuming at same time in engine combustion by construction of second fuel inlet for second fuel resulting a joint combustion in engine operation.

17. An engine according to claim 16, said operation of second fuel inlet sprays stored second fresh fuel directly into exploding combustion of first fuel at the time bringing a joint combustion in engine operation.

18. An engine according to claim 16, said operation of second fuel inlet sprays stored second fresh fuel with combustion into compressed first fuel bringing a joint combustion in engine operation.

19. An engine according to claim 16, includes construction of two inlets for two fuels spray their respective fresh fuels in consecutive time brings a joint combustion in engine operation.

20. An engine according to claim 16, includes construction of an inlet processing of spraying two different fresh fuels in consecutive time from a common nozzle brings a joint combustion in engine operation.
